(19) United States
(12) Patent Application Publication
(10) Pub. No.: US 2017/0120244 A1
(43) Pub. Date: May 4, 2017

(54) Modular Well Plates

(71) Applicant: Lonza Limited, Basel (CH)

(72) Inventor: Matthias Johannes FORSCHNER, Neckarsulm (DE)

(21) Appl. No.: 14/928,666

(22) Filed: Oct. 30, 2015

(51) Int. Cl. B01L 3/00

(52) U.S. Cl. CPC B01L 3/50855; B01L 3/50853; B01L 2300/0829; B01L 2300/0681; B01L 2300/041; B01L 2300/12; B01L 2200/028

(57) ABSTRACT

A filter plate with a flexible modular design. The filter plate has removable and completely closable rows and columns of wells, as well as removable and completely closable single or groups of wells.

### FIELD OF THE INVENTION

The present invention relates to a filter plate with a flexible modular design. More specifically, the filter plate of the present invention is designed to have removable and completely closable rows and columns of wells, as well as removable and completely closable single or groups of wells.

### BACKGROUND OF THE INVENTION

Filter plate or multi-well plate is a flat plate with multiple “wells” used as small test tubes. Filter plates may have wells or tubes that have single openings at their top ends, similar to conventional test tubes and centrifuge tubes, or they may incorporate second openings at their bottom ends which are fitted with frits or filter media to provide a filtration capability. A standard filter plate typically has 6, 24, 96, 384 or 1536 sample wells arranged in a 2×3 rectangular matrix with flat or round well bottoms. The well of a filter plate typically holds somewhere between tens of nanolitres to several millilitres of liquid. The filter plate has become a standard tool in analytical bioscience research and clinical diagnostic testing laboratories. In recent years, a number of companies have developed robots to specifically handle filter plates. These robots may be liquid handlers which aspirate or dispense liquid samples from and to these plates. Currently, the is the most commonly used well format because it can be used manually by a laboratory technician or a researcher, and at the same time is compatible with most automated equipment.

However, the wells of the presently available filter plates are not removable or usable to store liquids or samples temporary. For small-scale experiments, the entire plate has to be used. In addition, these plates are prone to cross-contamination, especially when packing multiple samples or resins at the same time using automated equipment. It is the object of the present invention to provide a filter plate designed to have removable rows and columns of wells, as well as removable single or groups of wells, and which are also compatible with all automation in bioscience. Lids at the top and the bottom side of the wells can be used to store liquids or samples temporary.

### SUMMARY OF THE INVENTION

The present invention provides a filter plate with a flexible modular design. In one aspect of the present invention, the filter plate comprises a frame; a plurality of wells arranged in individual rows, columns, disposed within the frame; wherein the individual rows or columns of wells are removable.

In another aspect of the present invention, the filter plate comprises a frame; a plurality of wells arranged in individual rows, columns, disposed within the frame; and a flat base portion adopted to support the plurality of wells, wherein the individual rows or columns of wells are removable.

In another aspect of the invention, the filter plate fits to a standard 96-well plate format.

In another aspect of the invention, the filter plate fits to other standard well plate formats.

In another aspect of the present invention, the filter plate comprises a frame; individual single wells disposed within the frame, wherein the individual single wells are removable.

In another aspect of the present invention, the filter plate comprises a frame and individual single wells disposed within the frame; and a flat base portion adopted to support the individual wells, wherein the individual single wells are removable.

The filter plate of the present invention is easy to clean, can be used for small-scale experiments by only inserting single wells, groups of wells, rows or columns of wells, allows mixing and matching of resin packing, and prevents well-to-well cross-contamination during packing. Lids at the top and the bottom side of the movable wells can be used to store liquids or samples temporary.

In another aspect of this invention, the filter plate comprises a frame; individual single wells disposed within the frame; and fasteners to attach the wells into the plate, wherein the individual single wells are removable.

In another aspect of this invention, the filter plate comprises a frame; individual single wells disposed within the frame; fasteners to attach the wells into the plate; and a flat base portion adopted to support the individual wells, wherein the individual single wells are removable.

In another aspect of this invention, the filter plate comprises a frame; a plurality of wells arranged in individual rows, columns, disposed within the frame; fasteners to attach the wells into the plate, wherein the individual rows or columns of wells are removable.

In another aspect of this invention, the filter plate comprises a frame; a plurality of wells arranged in individual rows, columns disposed within the frame; fasteners to attach the wells into the plate; and a flat base portion adopted to support the plurality of wells, wherein the individual rows or columns of wells are removable.

In another aspect of the present invention, any of the filter plates described herein can additionally comprise a lid.

In another aspect of the present invention, any of the filter plates described herein can additionally comprise a lid and fasteners to attach said lid.

In another aspect of the present invention, any of the filter plates described herein can be sterile or non-sterile.

In another aspect of the present invention, the frame of the filter plates can be adapted to automation handling.

In another aspect of the present invention, the height of the frame of the filter plates can be adjusted for barcoding and other labeling.

In another aspect of the present invention, the frame of the filter plates can comprise a conductive substance.

In another aspect of the present invention, the wells can comprise a conductive substance.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples. The disclosure is written for those skilled in the art. Although the disclosure uses terminology and acronyms that may not be familiar to the layperson, those skilled in the art will be familiar with the terminology and acronyms used herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an industry standard filter plate having 96 wells.

FIG. 2A illustrates a cross sectional view from the side of an industry standard filter plate.

FIG. 2B illustrates a close-up cross sectional view of a well fitted into a base portion of the filter plate of the present invention.

FIG. 3 illustrates an assembly of wells being fitted into a standard 96-well plate in accordance with one or more aspects of the present invention.

FIG. 4A illustrates the conditions when packing one, two, three or four different types of resins using a conventional filter plate having a 96-well format.

FIG. 4B illustrates the conditions when packing one, two, three or four different types of resins using a filter plate in accordance with one or more aspects of the present invention standardized to a 96-well format.

FIG. 5 illustrates a filter plate in accordance with one or more aspects of the present invention packed with 12 different types of resins.

FIG. 6 illustrates an example of a filter plate in accordance with one or more aspects of the present invention fitted with one row of wells.

FIG. 7 illustrates an example of fitting a row of wells into a filter plate in accordance with one or more aspects of the present invention.

### DETAILED DESCRIPTION

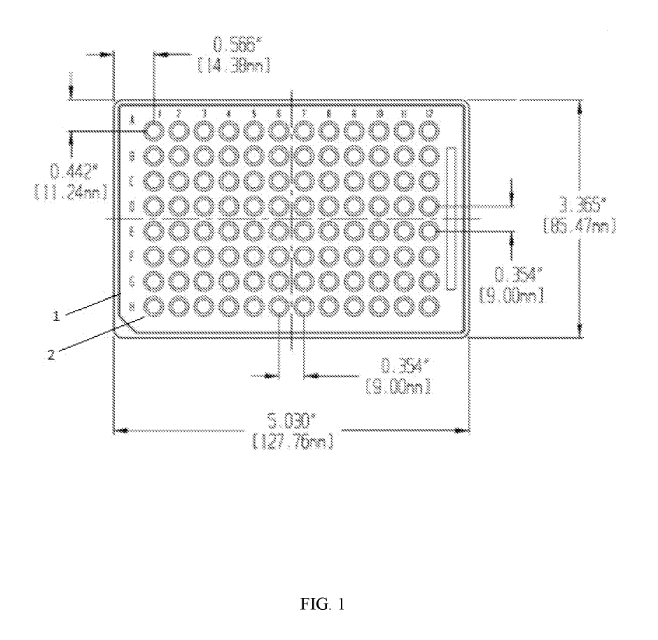

The present invention relates to a filter plate with a flexible modular design. In one aspect of the invention, the filter plate is designed to have removable rows of wells. For example, the filter plate comprises a frame; a plurality of wells arranged in individual rows, columns, disposed within the frame; and a flat base portion adopted to support the plurality of wells. In particular, the individual rows or columns of wells of the filter plate are removable. The boundaries between the individual rows or columns of wells of the filter plate may be perforated or otherwise made to allow individual rows or columns of wells to be separated or detached. In this example, the number and spacing of the wells have been standardized to the 96-well plate which has 8×12 wells spaced 9 mm center-to-center. The standard plate dimensions having 96 wells are illustrated in FIG. 1. By way of example, the filter plate of the present invention can be assembled from twelve separate strips of eight wells based on a 96-well format. Preferably, the plurality of wells fits to a standard 96 well format in order to be compatible with automated vacuum manifold devices. For instance, in order to ensure compatibility with automated vacuum manifold devices, the distance of the middle of the wells has to be the same as the dimensions of the standard filter plate illustrated in FIG. 1. Examples of automated vacuum manifold devices that can be used in conjunction with the filter plate include, but not limited to, ResiQuot and Te-VacS™. The filter plate of the present invention is intended for all applications in bioscience but can also be fitted for other research purposes.

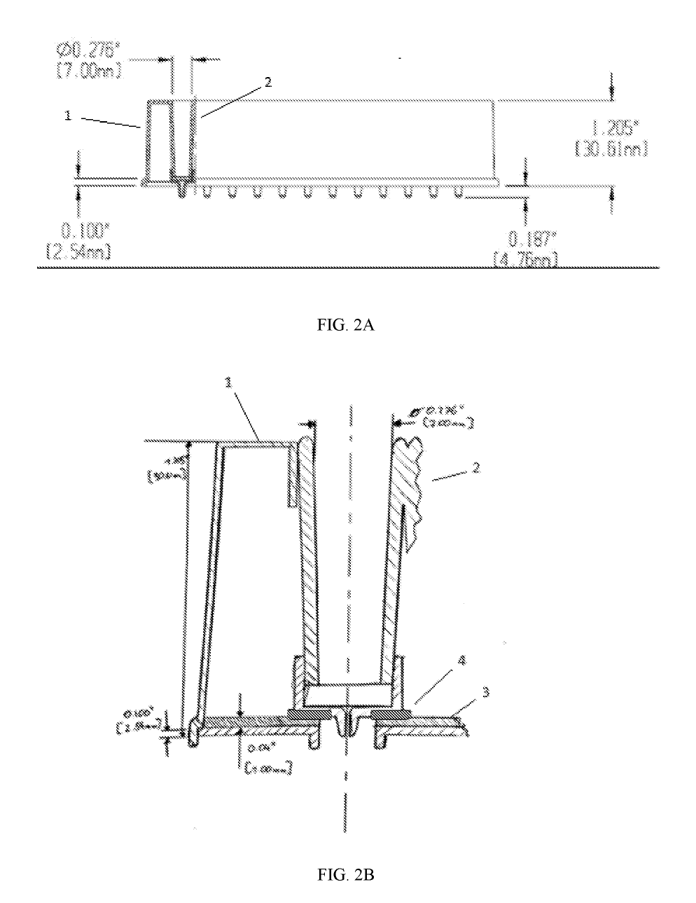

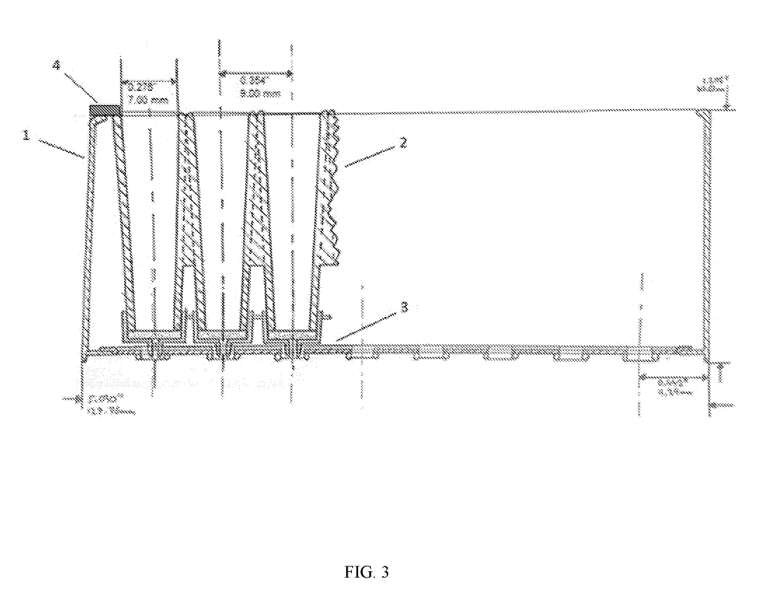

Referring to FIGS. 2A and 2B, the well diameter at opening, the well diameter at bottom of a conical tube, the well depth and the thickness of the perforated plate can all vary in size to suit the research purpose, as well as any different type of automation devices which uses filter plates. Preferably, the well diameter at opening (as illustrated in FIG. 2B) is at least 7.00 mm. The well diameter at opening should have sufficient space to allow a pipette into the wells for dispensing sample. Preferably, the well diameter at bottom of a conical tube is smaller in size than the well diameter at opening. FIG. 3 shows an assembly of wells fitted into a standard 96-well format. Preferably, the well volume ranges from 350 to 1000 μL.

In another aspect of the present invention, a collection plate is included to be placed underneath the filter plate to receive the sample after filtration. Preferably, the collection plate has the same dimensions as the filter plate.

In another aspect of the present invention, the plate has wells with solid or closed bottoms that allow the liquid to remain in the tubes.

In another aspect of the present invention, means for fastening or securing the wells to the base portion are included. For example, gaskets, tapes, fitted silicon, rubber elastic bands or clips may be used to seal or provide exact fit of the individual single wells or rows of wells to the base portion.

In another aspect of the present invention, means for fastening or securing the wells to the plate are included. For example, gaskets, tapes, fitted silicon, rubber elastic bands or clips may be used to seal or provide exact fit of the individual single wells or rows of wells to the plate.

In another aspect of the present invention, the filter plate comprises a frame; individual single wells disposed within the frame; and a flat base portion adopted to support the individual wells, wherein the individual single wells are removable.

In the present invention, the wells or tubes are reusable. The wells can be made from, but not limited to, plastic, metal, ceramic or aluminum. The filter plate frame and the base portion are reusable and can be made from, but not limited to, plastic, metal, ceramic or aluminum.

In the present invention, the wells or tubes are disposable. The wells can be made from, but not limited to, plastic, metal, ceramic or aluminum. The filter plate frame and the base portion are disposable can be made from, but not limited to, plastic, metal, ceramic or aluminum.

In another aspect of the present invention, a lid for the top side of the wells can be included as fastening for temporary storage and to prevent leakage. The lids can also be used to top off any unused wells.

In another aspect of the present invention, a lid for the bottom side of the wells can be included as fastening for temporary storage and to prevent leakage.

In another aspect of the present invention, a lid for the top side of the wells and a lid for the bottom side of the wells can be included to prevent leakage. The lids can also be used to top off any unused wells.

In another aspect of this invention, the lid for the top side can be designed to be easily attachable underneath a lid for the bottom side, thereby allowing easier storage or transport of the plates. In another embodiment, these lids will lock together in a stacking position, with, for example, fasteners.

In another aspect of the present invention, a fit, a contact, a runner or a rail can be placed on the top side of the filter plate which allows the automated vacuum manifold devices to be placed over the filter plate more easily.

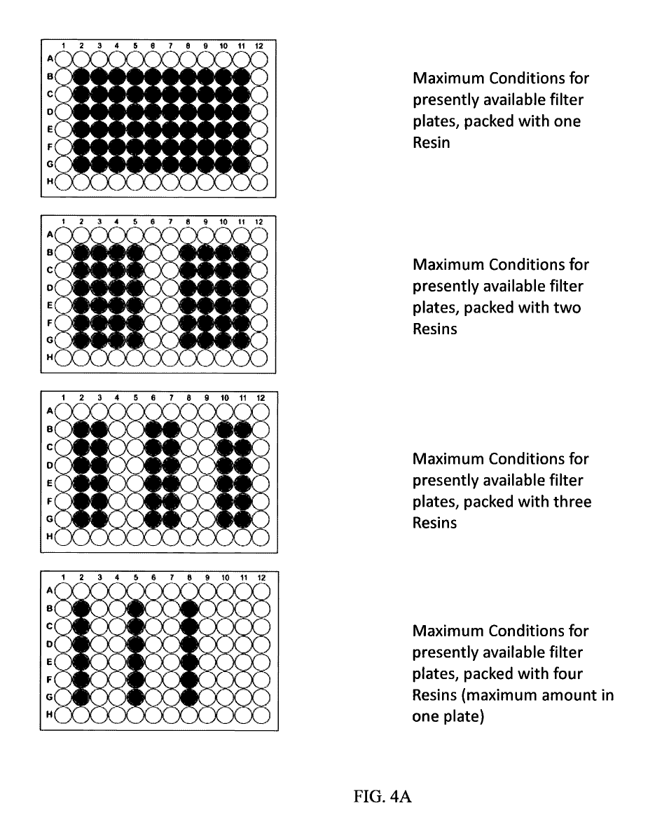

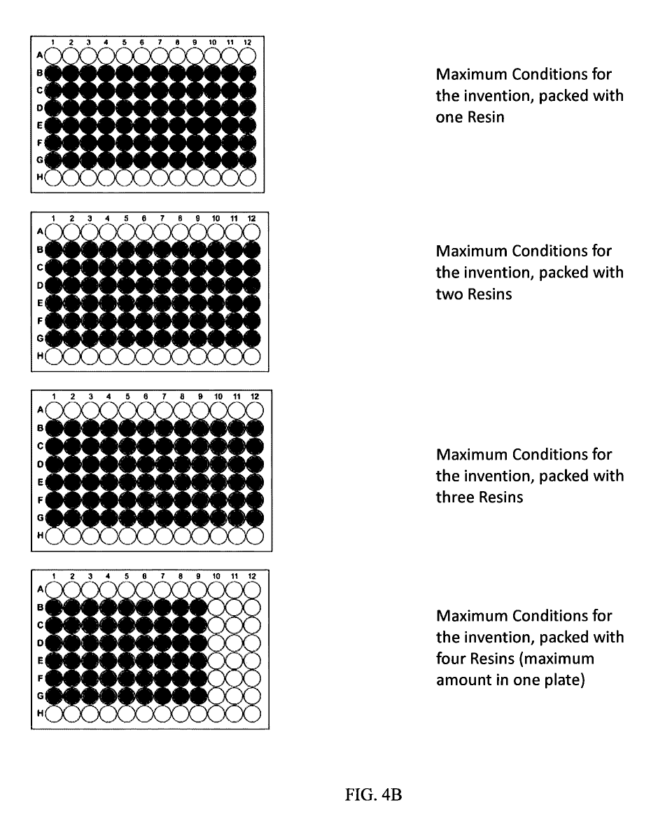

The present invention is advantageous in various ways. For example, the filter plate of the present invention is designed to allow packing of different types of resins into one plate. Currently, when packing different types of resins into one plate—in order to prevent cross-contamination between neighboring wells on the plate—it is necessary to leave the adjacent columns of wells empty. See e.g., FIGS. 4A and 4B. FIG. 4A illustrates the conditions when packing one, two, three or four different types of resins using a conventional filter plate having a 96-well format. In FIGS. 4A and 4B, the non-colored or unfilled rows and columns represent the emptied wells. Typically, the first and last rows of wells in the plate are left emptied. For comparison, FIG. 4B illustrates the conditions when packing one, two, three or four different types of resins using a filter plate in accordance with one or more aspects of the invention standardized to a 96-well format. As shown in FIG. 4B, different types of resins can all be packed into one plate. No wells are left unused or wasted. For example, up to 12 different types of resins can be fitted into one plate (see e.g., FIG. 5). However, the total number of resins that can be fitted onto one plate is limited only by the total number of wells. For example, for a 96-well plate, 96 different resins can be packed. This can be done, for example, by packing each resin in one well and placing each individual well into a plate or plate frame.

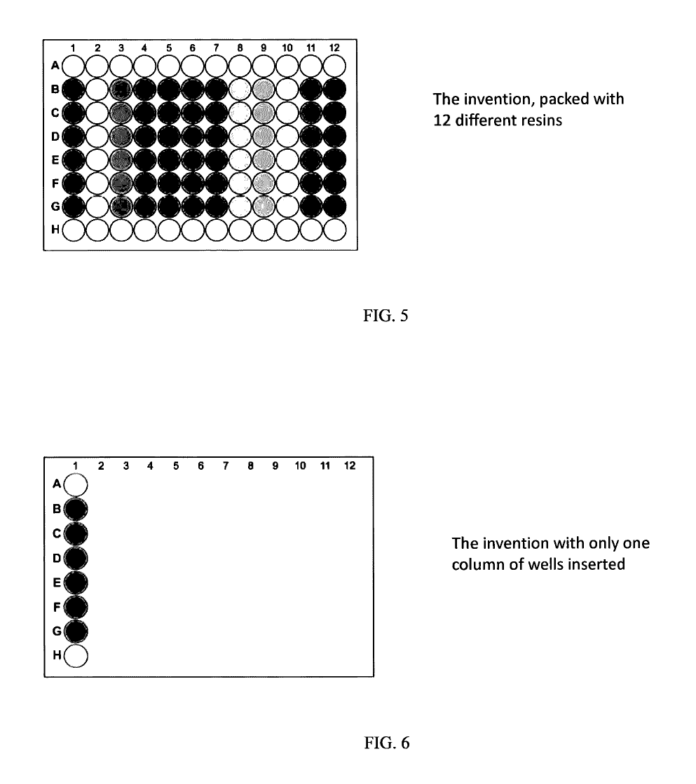

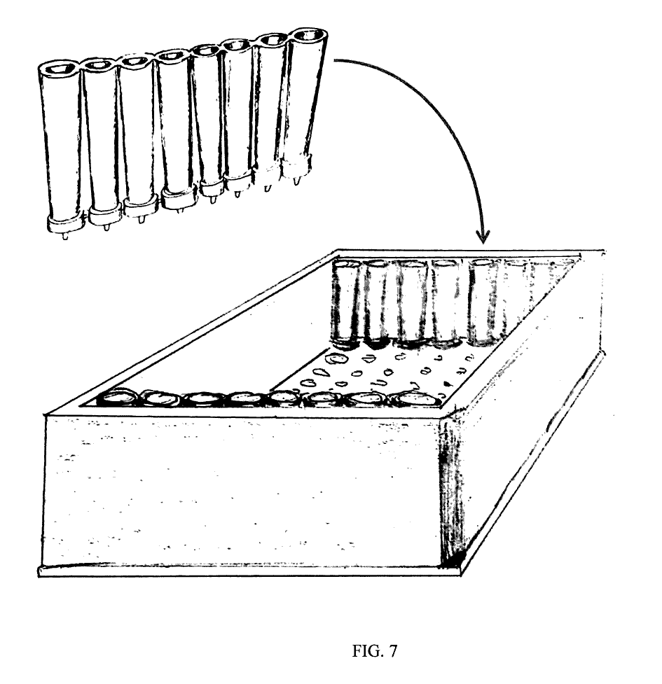

In addition, the filter plate of the present invention can be used for small-scale experiments. For instance, FIG. 6 illustrates a filter plate having only one row of wells inserted into the plate. If for example only one row is inserted into the perforated plate, the other non-used wells must be closed with the lid, or the other non-used holes in the perforated flat base portion must be closed, for using the filter plate in combination with a vacuum manifold device. In this way, the technician can design his/her own filter plate in accordance with the experimental scale by mixing and matching the well rows, or even individual wells. FIG. 7 illustrates an example of fitting a row of wells into a filter plate in accordance with one or more aspects of the invention.

Other objects, advantages and novel features of the present invention are apparent from the foregoing detailed description of the one or more preferred embodiments, examples and aspects. It should be recognized that the one or more examples in the disclosure are non-limiting examples and that the present invention is intended to encompass variations and equivalents of these examples.

1. A filter plate comprising a frame and a plurality of wells arranged in individual rows, columns, disposed within the frame, wherein the individual rows or columns of wells are removable.

2. The filter plate according to claim 1, wherein the filter plate fits to a standard 96-well plate format.

3. The filter plate according to claim 1, wherein the filter plate fits to other standard well plate format.

4. The filter plate according to claim 1, wherein the filter plate further comprises fasteners to attach the wells into the plate.

5. The filter plate according to claim 1, wherein the filter plate further comprises a flat base portion adopted to support the plurality of wells.

6. The filter plate according to claim 5, wherein the flat base portion is made of material that is disposable.

7. The filter plate according to claim 5, wherein the flat base portion is made of material that is reusable.

8. The filter plate according to claim 1, wherein the frame is made of material that is disposable.

9. The filter plate according to claim 1, wherein the frame is made of material that is reusable.

10. The filter plate according to claim 1, wherein the filter plate further comprises a lid on a top side of the plate.

11. The filter plate according to claim 10, wherein the filter plate further comprises fasteners to attach said lid.

12. The filter plate according claim 1, wherein the filter plate further comprises a lid for a top side of each well.

13. The filter plate according claim 1, wherein the filter plate further comprises a lid for a bottom side of each well.

14. The filter plate according claim 12, wherein the lid for the top side of each well is easily attachable underneath a lid for a bottom side of each well.

15. The filter plate according to claim 1, wherein each well has no openings at bottom side.

16. The filter plate according to claim 1, wherein the filter plate further comprises a collection plate placed underneath the filter plate.

17. The filter plate according to claim 1, wherein the wells are made of material that is disposable.

18. The filter plate according to claim 1, wherein the wells are made of material that is reusable.

19. The filter plate according to claim 1, wherein the frame and the wells are made from plastic, metal, ceramic or aluminum.

20. The filter plate according to claim 1, wherein the filter plate is made of material that is sterilized.

21. The filter plate according to claim 1, wherein the filter plate is made of material that is not sterilized.

22. The filter plate according to claim 1, wherein at least one part of at least one wall of the frame of the filter plate is adaptable to automation handling.

23. The filter plate according to claim 1, wherein at least one part of at least one wall of the frame of the filter plate is adjustable in height for barcoding or other labelling.

24. The filter plate according to claim 1, wherein the frame of the filter plate comprises a conductive substance.

25. The filter plate according to claim 1, wherein the wells comprise a conductive substance.

26. A filter plate comprising:
a frame;
a plurality of wells arranged in individual rows, columns, disposed within the frame;
fasteners to attach the wells into the plate; and
a flat base portion adopted to support the plurality of wells,
wherein the individual rows or columns of wells are removable.

27. A filter plate comprising a frame and individual single wells disposed within the frame, wherein the individual single wells are removable.

28. The filter plate according to claim 27, wherein the filter plate fits to a standard 96-well plate format.

29. The filter plate according to claim 27, wherein the filter plate fits to other standard well plate format.

30. The filter plate according to claim 27, wherein the filter plate further comprises fasteners to attach the wells into the plate.

31. The filter plate according to claim 27, wherein the filter plate further comprises a flat base portion adopted to support the individual single wells.

32. The filter plate according to claim 31, wherein the flat base portion is made of material that is disposable.

33. The filter plate according to claim 31, wherein the flat base portion is made of material that is reusable.

34. The filter plate according to claim 27, wherein the frame is made of material that is disposable.

35. The filter plate according to claim 27, wherein the frame is made of material that is reusable.

36. The filter plate according to claim 27, wherein the filter plate further comprises a lid on a top side of the plate.

37. The filter plate according to claim 36, wherein the filter plate further comprises fasteners to attach said lid.

38. The filter plate according claim 27, wherein the filter plate further comprises a lid for a top side of each well.

39. The filter plate according claim 27, wherein the filter plate further comprises a lid for a bottom side of each well.

40. The filter plate according claim 38, wherein the lid for the top side of each well is easily attachable underneath a lid for a bottom side of each well.

41. The filter plate according to claim 27, wherein each well has no openings at bottom side.

42. The filter plate according to claim 27, wherein the filter plate further comprises a collection plate placed underneath the filter plate.

43. The filter plate according to claim 27, wherein the wells are made of material that is disposable.

44. The filter plate according to claim 27, wherein the wells are made of material that is reusable.

45. The filter plate according to claim 27, wherein the frame and the wells are made from plastic, metal, ceramic or aluminum.

46. The filter plate according to claim 27, wherein the filter plate is made of material that is sterilized.

47. The filter plate according to claim 27, wherein the filter plate is made of material that is not sterilized.

48. The filter plate according to claim 27, wherein at least one part of at least one wall of the frame of the filter plate is adaptable to automation handling.

49. The filter plate according to claim 27, wherein at least one part of at least one wall of the frame of the filter plate is adjustable in height for barcoding or other labelling.

50. The filter plate according to claim 27, wherein the frame of the filter plate comprises a conductive substance.

51. The filter plate according to claim 27, wherein the wells comprise a conductive substance.

52. A filter plate comprising:
a frame;
individual single wells disposed within the frame;
fasteners to attach the wells into the plate; and
a flat base portion adopted to support the individual single wells,
wherein the individual single wells are removable.
